(19) United States
(12) Patent Application Publication
(10) Pub. No.: US 2026/0055240 A1
(43) Pub. Date: Feb. 26, 2026

(54) THIOL-MEDIATED PHOTO-OXIDATION OF PHOTOCURABLE SILICONES

(71) Applicant: Lawrence Livermore National Security, LLC, Livermore, CA (US)

(72) Inventors: Sijia Huang, Dublin, CA (US); Michael Ford, Livermore, CA (US)

(21) Appl. No.: 19/303,144

(22) Filed: Aug. 18, 2025

Related U.S. Application Data
(60) Provisional application No. 63/687,206, filed on Aug. 26, 2024.

(51) Int. Cl. C08G 77/08; B33Y 70/00; B33Y 80/00; C08G 77/28; C08K 5/06; C08K 5/14

(52) U.S. Cl. CPC C08G 77/08; B33Y 70/00; B33Y 80/00; C08G 77/28; C08K 5/06; C08K 5/14

(57) ABSTRACT

A composition for printing a three-dimensional siloxane structure includes a siloxane monomer having at least one silane functional group, a chain transfer agent, a hydrosilylation catalyst, a radical initiator, and a photo-oxidizing agent.

### RELATED APPLICATIONS

This application claims priority to U.S. Provisional Patent Application No. 63/687,206, filed on Aug. 26, 2024, which is herein incorporated by reference.

This invention was made with Government support under Contract No. DE-AC52-07NA27344 awarded by the United States Department of Energy. The Government has certain rights in the invention.

### FIELD OF THE INVENTION

The present invention relates to photocurable silicones, and more specifically to thiol-mediated photo-oxidation of photocurable silicones and methods and/or products thereof.

### BACKGROUND

The primary method for manufacturing silicone-based soft machines is injection molding. The demand for photocurable silicones is significant to achieve more intricate geometries. Various reports indicate that additive manufacturing (AM) of silicone-based materials can be achieved through direct-ink writing, vat photopolymerization, and material jetting. Presently, state-of-the-art silicone formulations for photocuring typically involve either incorporating a photo-protected Pt catalyst with reduced filler concentration or necessitate modifying silicone resin by introducing photocurable functional groups (such as acrylates or thiol-ene functionalities). Unfortunately, these alterations to the resin, while enabling AM, often result in compromised properties. Moreover, curing a silicon resin with light-mediated techniques is a relatively slow process for layer-by-layer printing where the time scale for curing each layer may be five to ten minutes.

To achieve high-performance photocurable silicones, a more straightforward approach is desired to enable AM using unmodified, readily available silicones that employ traditional Pt-catalyzed hydrosilylation chemistry for curing. However, traditional Pt-catalyzed hydrosilylation chemistry is known for its short shelf life (approximately 12 hours at room temperature). It would be desirable to achieve a stable resin that has an extended shelf life.

Hydrosilylation of vinyl-terminated polysiloxanes is an important reaction mechanism for the preparation of organosilicon compounds. One common example of this reaction primarily relies on the crosslinking of a vinyl-terminated polysiloxane macromer with a polysiloxane with hydride functionality along its backbone. This reaction proceeds to form a crosslinked elastomer, and by varying the individual components of the composition, the mechanical properties can be tuned so that useful elastomer material (e.g., rubbers) can be used for a variety of applications.

Although a single reactant that forms silicone elastomers is desirable, a process including a simplified composition having a realistic cure time without added heat remains elusive. Moreover, it would be desirable for a silicone composition to be applicable to the photocuring process of stereolithography techniques.

### SUMMARY

According to one embodiment, a composition for printing a three-dimensional siloxane structure includes a siloxane monomer having at least one silane functional group, a chain transfer agent, a hydrosilylation catalyst, a radical initiator, and a photo-oxidizing agent.

According to another embodiment, an additive for decreasing curing time of a siloxane resin under light includes a chain transfer agent, a radical initiator, and a photo-oxidizing agent.

According to yet another embodiment, a method of forming a three-dimensional (3D) structure includes obtaining a composition that comprises a siloxane monomer having at least one silane functional group, a chain transfer agent, a hydrosilylation catalyst, a radical initiator, and a photo-oxidizing agent. The method includes forming the 3D structure using the composition as a resin with an additive manufacturing process and curing the formed 3D structure, where the cured 3D structure includes a siloxane elastomer material.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 depicts a series of schematic drawings of reactions included in a curing reaction of silane-terminated siloxanes in the presence of a radical initiator, according to one embodiment. Part (a) hydrogen abstraction of peroxide and photoinitiator to generate a radical, part (b) radical transfer to the thiol group to form a thiyl radical, part (c) chain transfer of thiyl radical to siloxyl radical, part (d) formation of branching structures by coupling carbon radicals and silyl or siloxyl radicals, and part (e) formation of branching structures by a combination of silane-terminated siloxane monomers and vinyl-functionalized siloxane monomers.

FIG. 2 is a flow chart of a method of forming a three-dimensional structure using the siloxane composition with a chain transfer agent, a radical initiator, and a photo-oxidizing agent, according to one embodiment.

FIG. 3 is a plot of storage modulus and loss modulus of a composition having a chain transfer agent and a photo-oxidizing agent during periodic exposure to light, according to one embodiment.

FIG. 4 is an example of formation of a two-dimensional silicone elastomer structure, according to one embodiment. Part (a) is a drawing of a pattern, and part (b) is an image of the silicone elastomer structure having the photo-pattern of part (a).

FIG. 5 is an example of printing a three-dimensional structure having a complex geometry, according to one embodiment. Part (a) is a drawing of a gyroid structure, parts (b) and (c) are images of a three-dimensional structure in the form of a gyroid structure.

FIG. 6 is a plot of the stability of a resin having a chain transfer agent in the absence of light, according to one embodiment.

FIG. 7 is a plot of viscosity versus shear rate of a resin at different weeks after mixing, according to one embodiment.

FIG. 8A is a plot of viscosity versus shear rate of a resin at different weeks after mixing, according to one embodiment.

FIG. 8B is a plot of curing conversion over time of a resin at different weeks after mixing, according to one embodiment.

FIG. 9 is a plot of the UV curing conversion of a resin in terms of change in modulus, according to one embodiment.

FIG. 10 is a plot of curing conversion over time of a resin that includes different types of thermally activated initiator, according to one embodiment.

FIG. 11 depicts images of printed 3D structures, according to one embodiment. Part (a) a benchmark structure, part (b) a boat structure, and part (c) an earbud structure.

FIG. 12 is a plot of stress versus strain of different commercially available resins that include a curing additive mixture, according to one embodiment.

### DETAILED DESCRIPTION

The following description is made for the purpose of illustrating the general principles of the present invention and is not meant to limit the inventive aspects claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

As used herein, the term “essentially” denotes an interval of accuracy that ensures a meaning of “mostly” but may not be exclusively 100%. The term “essentially” may denote 99.0% to 99.9%.

It is also noted that, as used in the specification and the appended claims, wt. % is defined as the percentage of weight of a particular component relative to the total weight/mass of the formulation. Vol. % is defined as the percentage of volume of a particular compound relative to the total volume of the formulation or compound. Mol. % is defined as the percentage of moles of a particular component relative to the total moles of the formulation or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present and preferably results in a change of the characteristic to within a desired range. One skilled in the art, now armed with the teachings herein, would be able to readily determine an effective amount of a particular component without having to resort to undue experimentation.

In addition, the present disclosure includes several descriptions of a “resin” used in an additive manufacturing process to form the inventive aspects described herein. It should be understood that “resins” (and singular forms thereof) may be used interchangeably and refer to a composition of matter comprising a plurality of particles, small molecules, etc. coated with and dispersed throughout a liquid phase. In some inventive approaches, the resin may be optically transparent having a greater than 90% transmittance of light. In some inventive approaches, the resin is light sensitive where exposure to a particular light source changes the physical and/or chemical properties of the resin.

The following description discloses several preferred structures formed via photo polymerization processes, e.g., projection microstereolithography, photolithography, two photon polymerization, etc., or other equivalent techniques and therefore exhibit unique structural and compositional characteristics conveyed via the precise control allowed by such techniques. The physical characteristics of a structure formed by photo polymerization processes may include fabrication of a solid micro-structure having complex geometric arrangement of ligaments, filaments, etc. The three-dimensional structure formed from a resin exposed to light, wherein a pattern in the photoresist is created by the exposing light.

The following description discloses several preferred inventive aspects of thiol-mediated photo-oxidation of photocurable silicones and/or related systems and methods.

According to one general embodiment, a composition for printing a three-dimensional siloxane structure includes a siloxane monomer having at least one silane functional group, a chain transfer agent, a hydrosilylation catalyst, a radical initiator, and a photo-oxidizing agent.

According to another general embodiment, an additive for decreasing curing time of a siloxane resin under light includes a chain transfer agent, a radical initiator, and a photo-oxidizing agent.

According to yet another general embodiment, a method of forming a three-dimensional (3D) structure includes obtaining a composition that comprises a siloxane monomer having at least one silane functional group, a chain transfer agent, a hydrosilylation catalyst, a radical initiator, and a photo-oxidizing agent. The method includes forming the 3D structure using the composition as a resin with an additive manufacturing process and curing the formed 3D structure, where the cured 3D structure includes a siloxane elastomer material.

A list of acronyms used in the description is provided below.
2D two-dimensional
3D three-dimensional
AM additive manufacturing
C Celsius
DIW direct ink writing
DLP digital light processing
ppm parts per million
Pt Platinum
μm micron
SLA stereolithography
UV ultraviolet
wt. % weight percent

The present invention relates to the field of photopolymers, and more particularly pertains to resins suitable for stereolithography, two photon lithography, volumetric additive manufacturing, and UV-coating application. Conventional hydrosilylation of silicone elastomers includes the coupling of siloxanes with hydride and vinyl chemical functionalities with the addition of an appropriate catalyst (e.g., platinum-based catalysts). In particular, the reaction for elastomer formation relies on the presence of water and/or oxygen to form peroxides that allow crosslinking between the siloxane molecules.

However, achieving a curing process that allows printing a 3D siloxane structure has been elusive. For example, to form a 3D structure having millimeter dimensions, each layer having about a 50 μm thickness—and a millimeter-sized structure may have up to about 1000 layers—is preferably cured within one to two minutes to form the desired structure. However, if each layer takes longer than a few minutes to print, the structure cannot be formed up to millimeter sizes.

Current approaches in 3D printing using a photocuring process have not been able to successfully print a 3D structure using a siloxane resin because the reaction mechanism of curing siloxane monomers is difficult to trigger with light. According to one embodiment described herein, a siloxane resin that includes a chain transfer agent, such as a thiol siloxane polymer, accelerates a curing reaction that is triggered by light.

According to one embodiment, light-mediated printing techniques resulting in cured silicone resin includes radical chemistry that includes a chain transfer agent to improve efficiency in the photo-oxidation processes. As described herein, including a chain transfer agent in a siloxane resin benefits the process in at least three ways: a) accelerates the curing process by facilitating a transfer of the radical form the photoinitiator to the reactive polymers, b) allows spatial and temporal control of the photopolymerization of addition-cured silicones, and c) extends the shelf-life of the resin in the absence of light.

According to one embodiment, a composition of a siloxane resin includes additives for an efficient photopolymerization pathway for metal catalyst-cured silicones via addition reactions. In addition to a hydrosilylation metal catalyst, a siloxane composition includes additives that include a chain transfer agent, a radical initiator, and a photo-oxidizing agent. A chain transfer agent, such as a thiol siloxane polymer, functions to transfer the radical from the photoinitiator to the cured siloxane polymers and may accelerate the rate of metal catalysis of the hydrosilylation polymerization process. In one approach, a composition includes: a siloxane polymer with hydride functional groups, a siloxane polymer containing vinyl functional groups, a hydroperoxide or other organic peroxide, a photoinitiator, and a siloxane polymer incorporating a thiol functional group (e.g., a chain transfer agent).

The addition of thiol functional groups on the siloxane polymer of the chain transfer agent accelerates the photo-oxidation of photocuring silicones. Thiol may function as an effective chain transfer agent by transferring radical species to the vinyl functional group to form carbon radicals. This increase in reaction rate is crucial for additive manufacturing, enabling curing of a layer within one minute.

According to one embodiment, the incorporation of the additives, such as an organic peroxide (e.g., hydroperoxide), photoinitiator, and thiol-functionalized siloxane, allows a precisely controlled-spatially and temporally-photopolymerization of addition-cured silicones using light exposure. In one approach, the hydrosilylation reaction of siloxane polymers may be controlled spatially and temporally by interactions with the thiol functional groups of the chain transfer agent.

According to one embodiment, a method is described for creating photocurable silicones that involves photopolymerization of a cured precursor resin mixture. In a preferred approach, a composition of the resin for producing three-dimensional (3D) siloxane structure via additive manufacturing, includes: a siloxane polymer with at least one silane functional group, a chain transfer agent, a hydrosilylation catalyst, a radical initiator, and a photo-oxidizing agent.

In one aspect of the invention, the method for accelerating the curing of a siloxane-based resin may include a photo-protecting group on the siloxane polymer. In methods described by U.S. patent application Ser. No. 18/197,603, which is hereby incorporated by reference, a photo-oxidizing agent may be included in the curing process to accelerate the curing reaction. Including a photo-oxidizing agent allows the reaction to be controlled so that the reaction is triggered only by light, such that when the resin is not exposed to light, the reaction does not proceed. Printing with fine resolution relies on a control of the reaction where the reaction only proceeds in the presence of light and stops when the light is turned off. According to a preferred approach, a curing reaction is controlled by light irradiation.

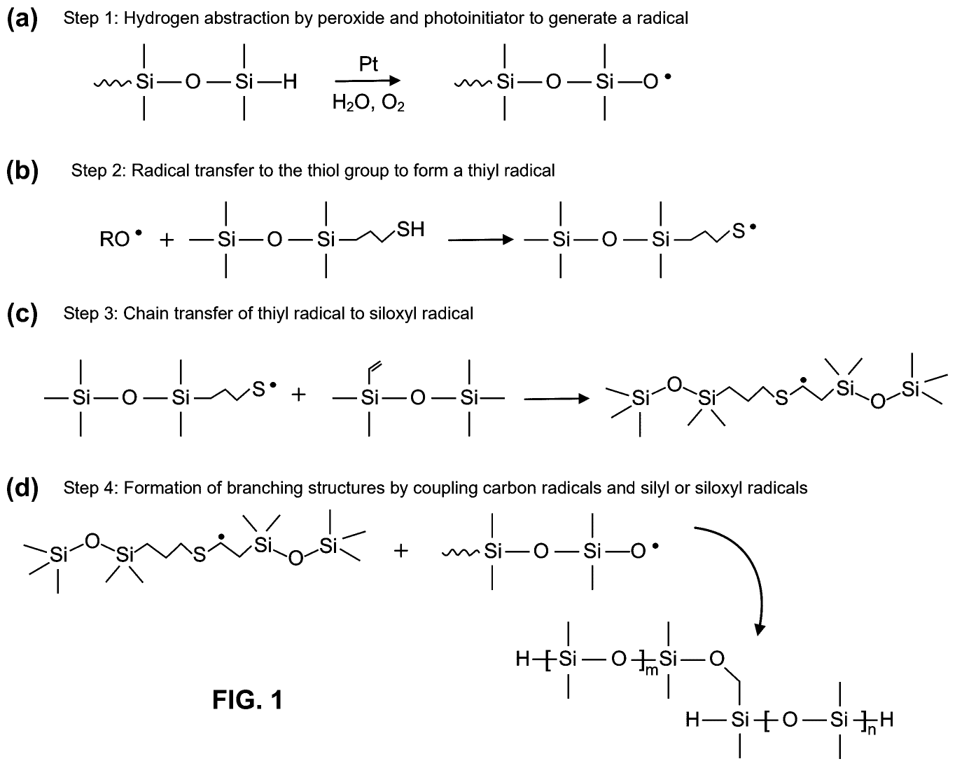

FIG. 1 illustrates a mechanism of peroxide-induced polymerization of siloxane monomers. Part (a) illustrates the hydrogen abstraction of a silane-terminated siloxane monomer by a catalyst Pt and a peroxide to generate a radical. The hydrogen abstraction may occur in the sole presence of water (H₂O) and oxygen (O₂), such as during ambient conditions including ambient humidity, however, the reaction proceeds slowly, for example up to 48 hours. The hydrogen abstraction reaction may be accelerated in the presence of a peroxide initiator (i.e., a radical initiator) and a chain transfer agent.

Part (b) illustrates the radical transfer to the thiol group to form a thiyl radical. Part (c) illustrates the chain transfer of thiyl radical to siloxyl radical. Part (d) illustrates the formation of branching structures by coupling carbon radicals and silyl or siloxyl radicals. Moreover, a chain transfer agent may facilitate spatial and temporal control of the curing reaction.

Part (e) illustrates the formation of branching structures by the combination of silane-terminated siloxane monomers and vinyl-functionalized siloxane monomers by traditional hydrosilylation. Since the presence of a vinyl crosslinker may result in an early hydrosilylation reaction, the introduction of a functional additive (e.g., chain transfer agent) may avoid preliminary curing by the traditional hydrosilylation reaction. A chain transfer agent may be included in the reaction mixture to facilitate spatial and temporal control of the hydrosilylation reaction.

### A Siloxane Composition for 3D Printing Using Light-Mediated Additive Manufacturing Techniques

According to a preferred approach, a composition of a resin for printing a 3D structure with siloxane elastomer material using photo stereolithography includes a hydride-terminated siloxane monomer, vinyl-terminated siloxane monomers, a hydrosilylation catalyst. a chain transfer agent, and a radical initiator.

In various embodiments, methodology as described herein may be extended to create recipes for a specific product that is formed by photopolymerization curing. In some approaches, properties (e.g., physical properties, mechanical properties, etc.) of the formed material may be tuned according to the formulation of components. In one exemplary approach, a product formulation may include silane-terminated silicones, a platinum catalyst, a chain transfer agent (e.g., such as a thiol siloxane polymer), a radical initiator, and a photo-oxidizing agent for photopolymerization.

In various approaches, the composition includes silicones (e.g., siloxanes) that may contain one or more silane functional groups. Silicones may be linear polymers, branched polymers, larger structures (e.g., resins), etc. Hydride-terminated siloxane monomers may be various forms including linear hydride-terminated siloxane monomer, a branched hydride-terminated siloxane monomer, a multifunctional hydride-terminated siloxane monomer, etc. The silane functional group may be pendant on the polymer. The silane functional group may be terminal on the polymer.

Siloxane polymer are polymers without typically any other functional groups besides silicone and oxygen, thus making them inert to chemical or temperature change. A current conventional method for printing siloxanes via photopolymerization includes incorporating acrylate functional groups into the silicone backbone. However, the presence of these functional groups compromises the chemical reactivity of the silicone polymer, for example, the polymer becomes more amenable to degradation at high temperatures, humidity, etc., and thus, an increased reactivity of an acrylate functionalized siloxane polymer may result in undesirable side reactions.

According to one embodiment, the resin includes a siloxane polymer that includes hydride functional groups. In one approach, the siloxane polymer includes vinyl functional groups. In one example, the siloxane polymer is stable from −40° C. to 400° C. Preferably, the siloxane polymer has minimal incorporation of acrylate functional groups into the siloxane polymer, where acrylate-functionalized siloxane material has been shown to be stable only between 0° C. and 200° C., thereby demonstrating that an acrylate-functionalized siloxane polymer loses thermal stability.

In some approaches, the composition may include a vinyl functionalized siloxane (e.g., a vinyl siloxane monomer) that accelerates the curing process. The presence of vinyl siloxane monomers in the composition may result in different material properties of the cured material. For example, with increasing amounts of vinyl siloxane monomer, the cured material has increased stiffness. The vinyl functional group may be at a terminal position. The vinyl functional group may be pendant on the polymer. Moreover, the presence of vinyl siloxane monomers in the formulation affects the curing kinetics, such as accelerating the curing reaction. In some approaches, the vinyl siloxane monomer may be a multifunctional vinyl siloxane monomer. In various approaches, the average molecular weight of the vinyl siloxane monomer may be in a range of about 1,000 to about 150,000 g/mol. The amount of vinyl-functionalized siloxane monomer in the formulation may range from greater than 0 to an equivalent amount of hydride-terminated siloxane monomer.

In one example, a formulation includes a hydride terminated siloxane macromer in the presence of various combinations of a platinum catalyst and a radical initiator. The polysiloxane may be a linear polysiloxane terminated by silane (i.e., hydrogen). In various approaches, silane-terminated siloxane monomer, including silane-terminated polysiloxanes, include branched silanes, multifunctional silanes, silane-based resins, etc.

In some approaches, the resin may include a blend of siloxane monomers that cure independently using the systems described herein. Preferably, a resin includes at least 85 wt. % siloxane monomers in a total weight of the resin. In some approaches, a resin includes at least 90 wt. % siloxane monomers, at least 95 wt. % siloxane monomers, at least 98 wt. % siloxane monomers, etc. These amounts are not meant to be limiting, and an amount of siloxane monomer in the resin may be between 85 wt. % to 98 wt. % of total resin. The siloxane monomer may be combination of hydride-terminated siloxane monomers, vinyl-terminated siloxane monomers, a siloxane monomer having at least one silane functional group, etc.

In some approaches, the hydride-terminated siloxane monomer is a macromer being a high molecular weight macromolecule with a single functional polymerizable group. In various approaches, hydride-terminated siloxane monomers may have an average molecular weight (MW) in a range between 1,000 and 100,000 gram/mol (g/mol).

According to one embodiment, the siloxane resin includes a chain transfer agent. In some approaches, the chain transfer agent may function as a radical initiator that accelerates the hydrosilylation reaction. In other approaches, the chain transfer agent may function to initiate a reaction independent of the hydrosilylation reaction that accelerates curing. In yet another approach, the chain transfer agent may function as a radical initiator that accelerates the hydrosilylation reaction and functions to initiate a reaction independent of the hydrosilylation reaction that accelerates the curing. The chain transfer agent functions as a catalyst to facilitate transfer of radicals from the photoinitiator to the siloxane monomers.

According to one embodiment, the chain transfer agent is a siloxane polymer with thiol functional groups that functions as a catalyst for accelerating the curing reaction. In addition, a chain transfer agent may be included in the curing reaction to allow the more efficient transfer of radicals from the photoinitiator to the curing reaction of the silicone chemistries. In one approach, a thiol functions as a radical transport to move radicals to improve chain transfer rate.

In one approach, the chain transfer agent is a siloxane polymer having a thiol functional group, hereafter referred to a thiol siloxane polymer. In some approaches, the chain transfer agent is a siloxane that has a mercapto group, sulfanyl group, thiol group, etc. in which the siloxane molecule has a functional group that contains a sulfur atom bonded to a hydrogen atom (—SH). In some approaches, the thiol siloxane may be obtained commercially. In various approaches, a chain transfer agent may include mercapto functional silicone fluid, (mercaptopropyl)methylsiloxane homopolymer, (mercaptopropyl)methylsiloxane-dimethylsiloxane copolymers, dimethylsiloxane with 3-mercaptopropyl methylsiloxane, etc. In one example, a thiol siloxane polymer may include mercaptopropyl terminated polydimethylsiloxane (PDMS) obtained from Gelest (DMS-SM21, Morrisville, PA).

In various approaches, an amount of chain transfer agent in the resin composition may be in a range of about 0.01 wt. % to about 10 wt. % of the total weight of the resin composition. In preferred approaches, an amount of chain transfer agent in the resin composition is in a range of about 0.01 wt. % to about 1 wt. % of the total weight of the composition. As illustrated in FIG. 1, the chain transfer agent reacts with the siloxane monomer that has been radicalized by the metal catalyst during the hydrosilylation reaction, thus, an amount of chain transfer agent is relative to the total weight of the composition. In some approaches where the chain transfer agent is a thiol siloxane polymer, an amount of thiol siloxane polymer may be in a range of about 0.01 wt. % to about 1 wt. % of the total weight of the composition and may be higher or lower. In a preferred approach, an amount thiol siloxane polymer may be in a range of about 0.1 wt. % to about 0.5 wt. % of the total weight of the composition. A higher amount of thiol siloxane polymer increases the stability of the resin and increase the efficiency of radical transfer during the reaction. However, at excess levels of thiol siloxane resin (e.g., above 1 wt. %) the resin the mechanical integrity of the siloxane polymers of part A and part B may be compromised, and the resin may yield undesired mechanical properties.

Preferably, an amount of thiol siloxane polymer is present in an effective amount to be an active component of the curing reaction, however the amount of thiol siloxane polymer is below an amount that would be a major component of the resin (e.g., an amount that competes with the vinyl siloxanes and hydride siloxane polymers). Preferably, the amount of thiol siloxane polymer is below 5 wt. % of the total weight of the composition. Moreover, an amount of thiol siloxane polymer below 0.01 wt. % may not be an effective amount to result in the inhibition of spontaneous polymerization of the resin (in the absence of light) and the spatial and temporal control of the photo-initiated curing of the resin. In some approaches, the thiol siloxane polymer has a molecular weight (g/mol) in a range of 500 to 10,000. In some approaches, the thiol siloxane polymer have a molecular weight in a range of 1,000 to 10,000 g/mol, 2,000 to 10,000 g/mol, 3,000 to 10,000 g/mol, 500 to 5,000 g/mol, 1000 to 5,000 g/mol, 2,000 to 5,000 g/mol, etc.

The composition of the resin preferably includes a hydrosilylation catalyst that abstracts hydrogen from the silicon atom of the silane group of the polysiloxane for initiating the reaction with a reactive silicone atom. In a preferred approach, the resin includes a hydrosilylation catalyst that is a platinum (Pt) catalyst for initiating the additive reactions between siloxane polymers. The Pt catalyst may be obtained commercially, e.g., Karstedt's catalyst, Ashby's catalyst, etc. In other approaches, the catalyst may be a metal catalyst such as rhodium, iridium, ruthenium, etc. In preferred approaches, an amount of the hydrosilylation catalyst in the resin is in a range of about 0.001 wt. % to about 1 wt. % of total weight of the composition including all the components of the composition.

For light-based curing, a composition includes components for initiating and controlling the curing reaction. In one approach, a composition includes an additive mixture that includes a chain transfer agent (e.g., thiol siloxane polymer), a radical initiator (e.g., a photoactivated initiator) and a photo-oxidizing agent (e.g., hydroperoxide or organic oxides) for generating and processing radicals in response to light. In one approach, a composition may include a radical inhibitor such as a photo absorbing material, which absorbs light.

As described herein, according to one embodiment, a radical initiator is included in the resin to initiate photopolymerization. In another approach, a peroxide that generates radicals via photoinitiation may allow for controllable photoinitiation of the crosslinking reaction. Furthermore, an additional inhibitor may be included, such as radical inhibitors/scavengers may be used to decrease the rate of reaction.

As described herein, an addition of radical initiators and inhibitors that are common for radical-based polymerization may be used to influence the rate of reaction of the hydride-terminated siloxane monomers (e.g., silane-terminated siloxane monomers, silane-pendant siloxane monomers, multi-silane siloxane monomers, etc.).

In another approach, an unsaturated imide, such as maleimide, may be included to inhibit Pt-catalyzed curing in the absence of light.

In various approaches, the radical initiator includes a photoactivated initiator. In some approaches, a photoactivated initiator may be referred to as a sensitizer (e.g., an accelerant) for boosting the rate of a peroxide-based crosslinking reaction. As listed in Table 1, the photoactivated initiator may include acetophenone, anthraquinone, benzil, benzophenone, 2-chlorothioxanthen-9-one (CTAO), 2,2-diethoxyacetophenone, 2,2-dimethoxy-2-phenylacetophenone (DMPA), 2-hydroxy-2-phenylacetophenone, 2-hydroxy-2-methylpropiophenone, thioxanthen-9-one, 3,4-dimethoxyacetophenone, 2,4,6-trimethylbenzoyldiphenylphosphinate (TPO-L), etc. In some approaches, photoactivated initiators may include monoketals, α-diketones, α-ketoaldehydes, acyloins, acyloin-corresponding ethers, etc. These examples are not meant to be limiting in any way, and further examples may include photoactivated initiators otherwise not mentioned herein.

In some approaches, a photoactivated initiator may function sufficiently as a photosensitizing agent so no additional photosensitizing agent may be needed in the composition. For example, DMPA functions as both a photoactivated initiator and a photosensitizing agent. Alternatively, a composition that includes the photoactivated initiator benzophenone preferably also includes a photosensitizing agent.

In various approaches, an amount of photoactivated initiator may be in a range of greater than about 0.01 wt. % to 4.0 wt. % of the weight of the total resin composition. In some approaches, the total resin composition may be essentially the total weight of siloxane monomers (hydride-terminated siloxane monomers, vinyl-terminated siloxane monomers, etc.) when no other comonomers are present in the composition.

In some approaches, a photoactivated initiator may also act as a photosensitizer (e.g., a photosensitizing agent) in the presence of the thermally activated initiator. In some approaches, a chain transfer agent may be included with a thermally activated initiator so that the thermal curing does not occur in the absence of light, thereby allowing the curing to be controlled with the exposure to light. In some approaches, a photosensitizing agent (e.g., sensitizers) may be included with a co-initiating species (e.g., a photoactivated initiator, a thermally activated initiator, etc.) to facilitate the formation of radicals with another co-initiating species and can often promote faster polymerization speeds under mild irradiation than compositions without sensitizers. In some approaches, a photosensitizing agent may be used to make a resin reactive when exposed to light at another wavelength of interest, such as 385 or 405 nm lamps that are common in some light directed AM apparatuses, e.g., SLA printers.

In various approaches, the composition includes a photosensitizing agent, such as a photo-oxidizing agent. In a preferred approach, the photo-oxidizing agent is an organic peroxide. In one example, the photo-oxidizing agent is a hydroperoxide.

In some approaches, a photosensitizing agent may include traditional dyes having aromatic units that absorb light between 420 nm to 280 nm. For example, as listed in Table 1, a photosensitizing agent may include at least one of the following: 2-chlorothioxanthone, 2,5-diphenyloxazole, pyrene, perylene, naphthalene, diispropylnapthalene (DIPN), anthracene, fluorene, biphenyl, phenanthrene, m-terphenyl, etc. 2-chlorothioxanthone may function as both a photoactivated initiator and a photosensitizing agent, the function may depend on the other components of the composition. These examples are not meant to be limiting in any way, and further examples may include photosensitizing agents otherwise not mentioned herein.

For some compositions, an amount of photo-oxidizing agent may be in a range of greater than 0.01 to 4 wt. % of the total weight of the composition. Preferably, the amount of added photo-oxidizing agent is equivalent to the amount of photoactivated initiator present in the composition. An amount of photo-oxidizing agent greater than 4 wt. % of the polysiloxane may accelerate the curing reaction, however, the excess components, such as the photoactivated initiator, thermally activated initiator, radical inhibitor etc., may have a detrimental effect on the mechanical properties of the material. For example, the non-polysiloxane additive components may diffuse, leach, and/or agglomerate within the cured material.

In some approaches, the radical initiator of the composition includes a thermally activated initiator. In a preferred approach, the radical initiator of a composition for photo-based curing includes a thermally activated initiator and a photoactivated initiator. The temperature of the curing reaction is preferably room temperature. Without wishing to be bound by any theory, the presence of a thermally activated initiator in the composition may at least function to disperse the additive materials (e.g., photoactivated initiator, photosensitizing agent, radical inhibitor, etc.) in the polysiloxane composition and accelerate the curing reaction at room temperature. For compositions for photo-based curing, an amount of thermally activated initiator may be in a range of greater than 0 to about 5 wt. % but may be higher to 10 wt. % of the total weight of the composition. Preferably, the amount of thermally activated initiator is in a range of greater than 1 to about 5 wt. % of the total weight of the composition.

In various approaches, the presence of a thermally activated initiator, such as a peroxide, enhances curing time of the siloxane resin that includes a chain transfer agent. Moreover, different peroxides may result in different curing times in the siloxane resin. Certain metrics associated with commercially available thermally activated initiators may indicate efficacy of an enhanced curing reaction. For example, without wishing to be bound by any theory, it is believed that a peroxide that functions at a higher temperature to initiate radical generation may be less efficient at curing at room temperature compared to a peroxide that functions at a lower temperature to initiate radical generation.

In one embodiment, for a thermal cure system where thermal cure is due to a Pt-based hydrosilylation reaction, a composition may include a chain transfer agent with a thermally activated initiator. The presence of the thiol functional group of the chain transfer agent blocks the Pt curing until exposure to UV light. For example, this embodiment may be implemented in high temperature processes where the silicone is already cast, but curing is preferentially delayed.

In some approaches, as listed in Table 1 below, a thermally activated initiator may include Luperox® 231 (1,1,Bis(tert-butylperoxy)-3,3,5-trimethylcyclohexane) (Arkema, Inc., Torrance, CA), 2,2-azobisisobutyronitrile, benzoyl peroxide, lauroyl peroxide, methyl acrylate, methyl methacrylate, etc. These examples are not meant to be limiting in any way, and further examples may include thermally activated initiators otherwise not mentioned herein.

Radical initiators may also be quenched by inhibitors, such as radical inhibitors, photoabsorbers, etc. For some hydrosilylation compositions, excess amounts of hydride functional polysiloxane are used. These excess hydrides could potentially react in the same way described previously in this report. This reaction may be unideal for applications where compression set can be of concern; the crosslinking of excess hydrides would increase the value of compression set. Thus, the addition of a radical inhibitor may be useful for preventing a compression set by this mechanism.

In some approaches, a radical inhibitor may be used that absorbs light between a different range of wavelengths that may be used for curing. In some approaches, an amount of inhibitor may be in a range of 0.05 wt. % to about 0.5 wt. % of total weight of the composition. Examples of inhibitors that may be used in the composition include: butylated hydroxytoluene, 4-methoxyphenol, hydroquinone, coumarins, etc.

In some approaches, the composition may include an additive, such as a photopolymerization inhibitor, e.g., a photoabsorber. With some photoactive resins used in light-directed 3D printing, polymerization may propagate outside the intended projection area, thereby decreasing part resolution as well as potentially creating inhomogeneities in the resin bath (and subsequently the printed part) as resin becomes partially polymerized. This may be prevented by including various additives in the resin composition. In some approaches, the additive may include various types of photoinhibitors. In one approach, one type of photoinhibitor, e.g., a UV blocker, absorbs stray photons and limits spread and penetration depth of light into resin, thereby minimizing photoinitiation outside of the intended projection area. In another approach, another type of photoinhibitor causes chemical quenching, where compounds actively quench or terminate polymerization reactions.

In some approaches, a formulation of the composition may include small molecules for adjusting the viscosity of the resin, ink, etc. that are soluble in one or more siloxane monomers. In some approaches, the resin may include silica, binder, etc. The composition may also contain other macromers, functional siloxanes, or silica. With the addition of silica, the composition could be used for additive manufacturing, which would benefit from the orthogonal curing of hydrosilylation and peroxide-initiated coupling of the hydride groups. Orthogonal curing may be defined as there may be distinct reaction occurring in the composition in addition to the curing reaction. In one approach, in one composition, one reaction occurs according to a thermal time scale, and a second reaction occurs according to a photo-curing based time scale. The time scale for each reaction may be different. In conventional curing reactions of polysiloxanes, a coupling reaction occurs simultaneously with the curing reaction. As described herein, the coupling reaction of the siloxane monomers may occur at a different time using a different mechanism as the curing reaction in the same composition.

Table 1 lists examples of each component of the composition, and lists examples of silicones, such as hydride terminated polydimethylsiloxane (PDMS), (10,000 cSt) (DMS-H41, Gelest, Morrisville, PA), hydride terminated polydimethylsiloxane, (500 cSt) (DMS-H25, Gelest), monohydride terminated polydimethylsiloxane, asymmetric, (150-250 cSt) (HCR-H22, Gelest), methylhydrosiloxane-dimethylsiloxane copolymer,

TABLE 1
Examples of components of various resins

| | Chain | | Thermally- | |
|---|---|---|---|---|
| | transfer | Photoactivated | activated | |
| Silicones | agent | initiators | Initiators | Photosensitizers |
| DMS-H41¹ | DMS- | Acetophenone | 2-2′- | Pyrene |
| | SM21¹ | | Azobis- | |
| | | | isobutyronitrile | |
| DMS-H25¹ | SMS-022¹ | Anthraquinone | Benzoyl | Perylene |
| | | | peroxide | |
| MCR-H22¹ | SMS-042¹ | Benzil | Lauroyl | Naphthalene |
| | | | peroxide | |
| DMS-HXX² + | SMS-142¹ | Benzophenone | 1,1-Bis(tert- | Anthracene |
| VDT-731¹ | | | butylperoxy)- | |
| | | | 3,3,5- | |
| | | | trimethlcyclohexane⁴ | |
| DMS-HXX + | SMS-992¹ | 2- | Luperox ® | Fluorene |
| MQV¹ | | Chlorothioxanthen- | 331M80, 1,1- | |
| | | 9-one | Bis(tert- | |
| | | | butylperoxy) | |
| | | | cyclohexane | |
| | | | solution | |
| Sylgard ™ | GP-367⁵ | 2,2- | Luperox ® DI, | Biphenyl |
| 184³ | | Diethoxyacetophenone | tert-Butyl | |
| | | | peroxide | |
| HMS-031¹ | GP-71-SS⁵ | 2,2-Dimethoxy-2- | | Phenanthrene |
| | | phenylacetophenone | | |
| | GP-800⁵ | 2-Hydroxy-2- | | 2,5- |
| | | methylpropiophenone | | Diphenyloxazole |
| | GP-710⁵ | Thioxanthen-9-one | | m-Terphenyl |

¹Gelest, Morrisville, PA
²DMS-HXX refers to any number from Gelest (e.g., DMS-H41, DMS-H25, etc.)
³Dow Chemical Company, Midland, MI
⁴Luperox ® 231, Arkema, Inc., Torrance, CA
⁵Gebesee Polymers Corporation., Burton, MI

trimethylsiloxane terminated (25-35 cSt) (HMS-031), polydimethylsiloxane, etc. These are by way of example only and are not meant to be limiting in any way. In some approaches, the composition may include combinations of different hydride-terminated siloxane monomers. For example, the composition may include a combination of monomers, macromers, etc. In preferred approaches, the hydride-terminated siloxane monomers include multisilane siloxane monomers, for example, branched silane-terminated siloxane monomers, multisilane crosslinkers, silane-terminated resins, organofunctional silanes, etc.

A fast hydrosilylation reaction with the addition of photoactivated initiators may improve the fidelity of printed parts and a fast crosslinking reaction ensures that these parts maintain their final shape. The composition may also use other catalysts that are less efficient for crosslinking but could be useful for chain extension or other modifications to the hydride-functional polysiloxane.

For example, in one composition, silane-terminated siloxanes and vinyl-terminated siloxanes may be combined to a long, single stranded polymer using a thermal-based coupling reaction, and then a second reaction being a photo-based curing reaction causes the polymers to cure into a material having specific mechanical properties.

Moreover, it was surprising that the uncured mixture of siloxane resin (part A+part B) that included the chain transfer agent (e.g., thiol siloxane) has an increased shelf life of several months where the mixture does not cure in the absence of light. It was unexpected that the presence of the chain transfer agent was sufficient to inhibit the spontaneous polymerization of siloxane polymers (in the absence of light) that resulted in the mixture gelling thereby rendering the mixture unusable.

### An Additive Mixture for Optimal Curing

In one embodiment, an additive mixture for optimal curing may be added to a siloxane resin for converting the resin for optimizing the siloxane resin for light-mediated printing of 3D structures. In a preferred approach, an additive mixture is added to a siloxane resin to decrease the curing time of the siloxane resin under light thereby allowed faster printing of complex 3D structures using light mediated techniques. The additive mixture is a combination of additives where each additive functions to promote spatial and temporal control of the curing reaction during 3D printing of a silicone structure. In one approach, the additive mixture includes a chain transfer agent, a radical initiator, and a photo-oxidizing agent. In some approaches, a formulation of the composition may include an additive mixture that includes a radical inhibitor, a chain transfer agent, a photo-oxidizing agent, a photoabsorber, a photoinhibitor, etc. depending on the wavelength of light being used for light-directed AM and/or curing.

As described herein, the components of the additive mixture include a chain transfer agent that may be a thiol siloxane polymer. The radical initiator may include a photoactivated initiator. In another approach, the radical initiator may include a thermal activated initiator. In yet another approach, the radical initiator may include a photoactivated initiator and a thermal activated initiator. In various approaches, the additive mixture includes a photo-oxidizing agent such as an organic peroxide. In one approach, the photo-oxidizing agent is a hydroperoxide.

In some approaches, an additive mixture is a catalyst/initiator mixture and includes a catalyst for a hydrosilylation reaction, a second catalyst for a radical initiated reaction (e.g., a chain transfer agent), a photoactivated initiator, and a photo-oxidizing agent. In one approach, the additive mixture may include a catalyst, a photoactivated initiator, a photosensitizing agent, a chain transfer agent, and a thermally activated initiator.

According to one embodiment, the additive mixture may be used for optimizing the curing reaction of a polysiloxane resin during an additive manufacturing technique to form a 3D structure, where the polysiloxane resin is purchased commercially. The additive mixture would serve as a kit to promote temporal and spatial control of photo (i.e., UV) cure during AM of a 3D structure. In some approaches, an additive mixture may be engineered to switch the mechanism from thermally activated initiated curing mechanism to a radiation-initiated curing mechanism of siloxane monomers.

In one example, a conventional two-part silicone thermal curing molding resin that includes a hydrosilylation catalyst (e.g., Sylgard™ 184 silicone) may be converted to a photo-curable resin by adding an additive mixture that includes a radical initiator mixture of photoactivated initiator+thermally activated initiator/photo-oxidizing agent, +chain transfer agent+photosensitizing agent, such that the resin+additive mixture may be cured by exposure to UV light at room temperature.

In various approaches, an amount of additive mixture added to a formulation of the composition may be in a range of greater than 0 wt. % to 15 wt. % of the weight of the total composition. A formulation of the composition having an additive mixture may include an amount of siloxane monomer+hydrosilylation catalyst in range of 85 wt. % to nearly 100 wt. % of the weight of the total composition. In preferred approaches, an amount of additive mixture may be present in a range of 4 wt. % to 10 wt. % for a composition having the formulation 96 wt. % to 90 wt. % siloxane monomers+hydrosilylation catalyst, respectively. Commercially available siloxane resins that include a hydrosilylation catalyst include Sylgard, Dragon Skin, Form Labs, Eco Flex, etc.

### A Method of Forming a 3D Structure Using a Siloxane Composition Having a Chain Transfer Agent

According to one embodiment, a composition includes hydride-terminated siloxane monomers, a hydrosilylation catalyst, a chain transfer agent, a radical initiator, and a photo-oxidizing agent for temporally and spatially controlling the curing of the composition to form a 3D structure of siloxane elastomer material. In one approach, the composition is a product for the use of additive manufacturing processes. In one approach, the composition is a resin for forming a structure using a stereolithography additive manufacturing technique. In another approach, the composition is an ink for forming a structure using a direct ink writing additive manufacturing technique.

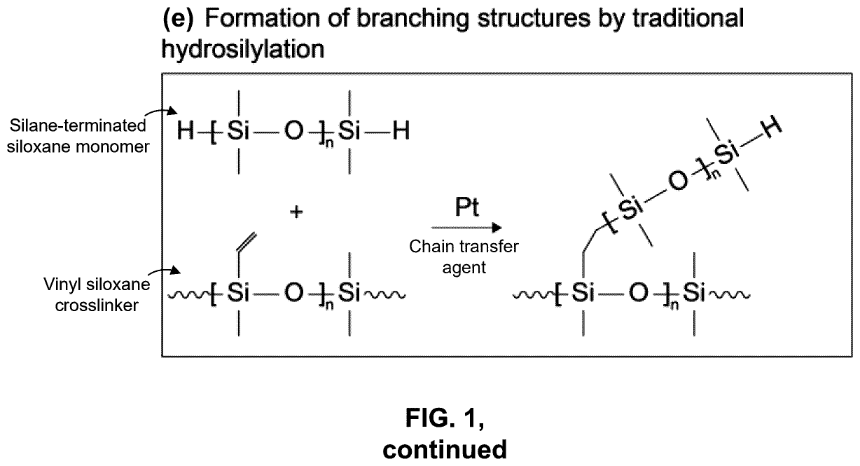

FIG. 2 shows flowchart for a method 200 for forming a three-dimensional (3D) structure, in accordance with one inventive aspect. As an option, the present method 200 may be implemented to construct structures such as those shown in the other FIGS. described herein. Of course, however, this method 200 and others presented herein may be used to form structures for a wide variety of devices and/or purposes which may or may not be related to the illustrative inventive aspects listed herein. Further, the methods presented herein may be carried out in any desired environment. Moreover, more, or less steps than those shown in FIG. 2 may be included in method 200, according to various inventive aspects. It should also be noted that any of the aforementioned features may be used in any of the inventive aspects described in accordance with the various methods.

Operation 202 includes obtaining a composition where the composition includes a siloxane monomer having at least one silane functional group, a hydrosilylation catalyst, a chain transfer agent, a radical initiator, and a photo-oxidizing agent. In one approach, the composition includes a siloxane monomer having at least one silane functional group, a hydrosilylation catalyst and an additive mixture, where the additive mixture includes a chain transfer agent, a radical initiator, and a photo-oxidizing agent. The composition does not include a solvent. In one approach, the composition includes components as described more fully herein.

In one approach, the radical initiator of the composition includes a photoactivated initiator and a thermally activated initiator. In another approach, the radical initiator of the composition includes a photoactivated initiator, a photosensitizing agent, and thermally activated initiator.

In one approach, a thermally initiated peroxide (e.g., a thermally activated initiator) may be added to increase the rate of reaction.

Operation 204 includes forming the 3D structure using the composition as a resin with an additive manufacturing process. In various approaches, silicone elastomer products may be fabricated using 3D printers using UV light to cure resins in a layer-by-layer fashion. In one approach, a 3D printer may be a stereolithography (SLA) type printer that uses a rastered UV laser. In another approach, the 3D printer may be a digital light processing (DLP) type printer that uses a projected mask with a UV light.

In some approaches, the 3D structure is self-supporting prior to curing. The 3D structure formed using the composition as ink, resin, etc. includes self-supporting walls arranged in a pre-defined pattern. In some approaches, the formulation of the composition may be designed to be sufficiently mechanically robust for self-supporting complex architectures. Moreover, the formulation allows formation of a mechanically stable structure having an aspect ratio capable of supporting its own weight, e.g., a self-supporting structure, prior to curing.

Operation 206 includes curing the formed 3D structure for forming a siloxane elastomer material. In one approach, the curing may include exposing the composition to light for polymerizing the composition to form a structure having a siloxane elastomer material. The curing of the 3D structure includes exposure of the composition material to light. In a preferred approach, the 3D structure formed from the composition is cured during exposure to radiation at an ambient temperature (e.g., room temperature). In one approach, the composition is warmed to room temperature to initiate polymerization of the composition. In another approach, the curing includes heating to initiate thermal curing of the composition.

In some approaches, operations 204 and 206 of forming a 3D structure and curing the formed 3D structure may occur simultaneously. For example, a projection micro-stereolithography (PμSL) technique uses a light to form the 3D structure according to a predefined pattern where the resin is cured upon exposure to the light.

As described herein, the radical-based polymerization reaction may be orthogonal to a hydrosilylation reaction, so vinyl functionalized macromers may be added to modify properties to make highly stretchable polysiloxanes (e.g., >1000% strain), ultrasoft polysiloxanes, and other polysiloxanes with targeted mechanical properties. In preferred approaches, vinyl functionalized macromers may be added simultaneously in the composition as the hydride-terminated macromers. The respective reactions may proceed in either order. For example, photo-oxidation may be initiated first, and hydrosilylation is inhibited so that it occurs after photo-oxidation. Alternatively, conditions may be tuned so that the hydrosilylation reaction occurs first, followed by photo-oxidation.

The duration of the curing may depend on several factors such as the size of the sample, the radical initiator, the intensity of the light, etc. For each printed layer, the layer is preferably cured to a predefined extent to support a subsequent layer of material. In some approaches, each layer is cured within 5 minutes. Preferably, each layer is cured within 120 seconds.

In various approaches, the temperature of the curing may be in a range of room temperature up to 90° C. In one approach, temperature of the photo-based curing reaction of the composition may be in the range of room temperature up to 90° C. Most printers for additive manufacturing are used at about 60° C. (for example, SLA/DLP printing technologies).

The method 200 as shown in FIG. 2 of forming a 3D structure is highly scalable and compatible with additive manufacturing (e.g., light-based 3D printing methods such as digital light processing, PμSL, etc.). In various approaches, the product has physical characteristics of formation by an additive manufacturing technique. In various approaches, physical characteristics may include filaments arranged in a geometric pattern, a patterned outer surface defined by stacking filaments, etc. Thus, using these additive manufacturing techniques allows engineering of parts and production of optimal geometry for efficient radiation detection and mechanical strength.

In various approaches, a printed 3D structure may be printed using the siloxane resin where the structure has predefined fine features. In one example, a printed 3D structure having dimensions in millimeter lengths has micron-scale features that characterize details of a predefined structure, e.g., a 3D boat, an earbud, etc.

In a preferred approach, the composition may be exposed to the light during performance of an additive manufacturing technique that uses the composition as a resin for formation of a three-dimensional structure having a geometric pattern. This composition may be cured using a light defined by the radical initiator, for example using a light having a wavelength in a range of 420 nm to 280 nm. Application of the light may include shining the light using a separate lamp, an additive manufacturing apparatus incorporating such a lamp, a laser at a similar wavelength, etc.

Rapid light-induced polymerization of a polysiloxane resin composition allows printing of structures having precise, fine features, e.g., filaments, ligaments, etc.

In some approaches, the rapid curing of radical-mediated polymerization may allow a print image of a building part to be changed between layers, allowing for non-monolithic print geometry. For example, a part may be built in a bath of uncured resin. For each layer, the light is specifically focused on a 2D projection plane where the resin exposed to UV light is cured. The part then is moved away from the projection plane, recoated with resin, brought back to the image plane within the bath, and cured. This process allows the next layer to be cured on the same plane, thus enabling the print image to be changed between layers. This process thereby forms a product having a non-monolithic geometry.

### A Method for Extending the Shelf-Life of a Siloxane Resin

According to one embodiment, the inclusion of thiol-functionalized siloxane in the resin composition significantly extends the shelf life of the resin in the absence of light. By incorporating thiol functional groups in a chain transfer agent, the thiol groups may function as temporary inhibitors for the metal catalyst thereby extending the shelf life of the resin. According to one embodiment, a method for extending a shelf life of a siloxane resin includes adding an effective amount of a thiol siloxane polymer to extend a shelf life of the siloxane resin by at least a year. In one approach, the method includes adding an effective amount of thiol siloxane polymer to a precursor silicone resin, before curing, to extend the shelf-life of the precursor silicone resin for weeks, months, and possibly years.

It was useful that the presence of a thiol-functionalized siloxane polymer in a siloxane resin prevented the siloxane resin from gelling at room temperature over a long period of time, such as greater than 10 hours. Further, it was surprising that the thiol-functionalized siloxane polymer included to enhance the UV-mediated polymerization also functions as a stabilizer/inhibitor in the siloxane resin in the absence of UV and prevented the siloxane resin from gelling for long extended periods of time at room temperature, for example, providing a shelf life of greater than 2 weeks, greater than several months, and even greater than a year. Conventional use of commercially available siloxane resins include mixing a part A and a part B that may result in a gelled mixture in a short period of time and consequently may have a short shelf life. In one example, a commercially available siloxane resin having mixed parts A and B becomes a gelled mixture after only about 6 to 8 hours at room temperature. In a conventional setting, once the parts are mixed together, the mixture increases in viscosity and then completely cures by metal-catalyzed addition in 8 hours in the absence of exposure to light. Thus, the processing window for printing a siloxane resin mixture is typically limited to less than 6 hours, which is challenging and unworkable for scaling the process to large production.

In the absence of UV-light, the presence of the thiol siloxane polymer functions as a stabilizer that inhibits spontaneous polymerization of the siloxane polymers (e.g., in the absence of light) for a duration of time that may extend to several months, and then upon introduction of UV light, the thiol siloxane polymer present in the siloxane resin no longer functions as an inhibitor and functions to mediate better radical chain transfer thereby enhancing UV-mediated polymerization of the resin. Without wishing to be bound by any theory, it is believed that the thiol groups associate, and temporarily bind, to key functional groups that participate in a metal-catalyzed curing reaction thereby inhibiting spontaneous curing of the siloxane resin (in the absence of light).

Addition of a thiol-functionalized siloxane polymer, as described herein, may provide a solution to the issue of poor shelf life of siloxane resins. According to one embodiment described herein, addition of a thiol siloxane polymer to a siloxane resin mixture extends the shelf life of the siloxane resin mixture in a manner that the siloxane resin mixture does not proceed to a gelling stage (i.e., is prevented from gelling) at room temperature for at least 2 months to more than a year. In some approaches, addition of a thiol siloxane polymer to a siloxane resin may extend the shelf life of the siloxane resin to more than a year at room temperature. In one approach, addition of a thiol siloxane polymer to a siloxane resin may extend the shelf life of the siloxane resin to multiple years. For a two-part siloxane resin system, the shelf life of a combined siloxane resin (part A+part B) may be extended to at least a year or longer without the viscosity of the combined siloxane resin increasing to a gel state.

In one approach, a thiol siloxane polymer may be added to a siloxane resin in an effective amount that prevents the siloxane resin from gelling at room temperature for greater than 2 months, 6 months, 1 year, 2 years, etc. The effective amount of a thiol siloxane polymer added to the resin may be in a range of about at least 0.01 wt. % to about 10 wt. % of total weight of the siloxane components of the resin (a mixture of part A and part B siloxanes). A preferred range of chain transfer agent may be in a range of 0.01 wt. % to about 5 wt. %. In some approaches, addition of a higher amount of chain transfer agent to the siloxane resin may increase the stability of the siloxane resin mixture for greater than one year. However, in some formulations, higher amounts of chain transfer agent may adversely affect the mechanical properties of the product formed with the siloxane resin having a higher amount of chain transfer agent for resin shelf life stability. In various approaches, the effective amount of thiol siloxane polymer may be determined by one skilled in the art after reading the present disclosure via routine experimentation.

In one example, an amount of 0.1 wt. % thiol siloxane polymer of total siloxane components of the resin causes the mixture of siloxane polymer resin to remain stable without gelling for about 1 to 2 months. In the presence of the thiol siloxane polymer in the absence of light, the resin does not change viscosity and does not form a gel. Then, in the presence of a light (e.g., photostereolithography), the mixture cures to form a printed 3D structure as expected. Including a thiol-functionalized siloxane polymer in the siloxane mixture causes the mixture to be stable at ambient temperature in the absence of exposure to light, and then once the mixture is exposed to light, the curing reaction of the mixture proceeds. The presence of a thiol functional group allows the temporal and spatial control of the siloxane formulation.

### Experiments

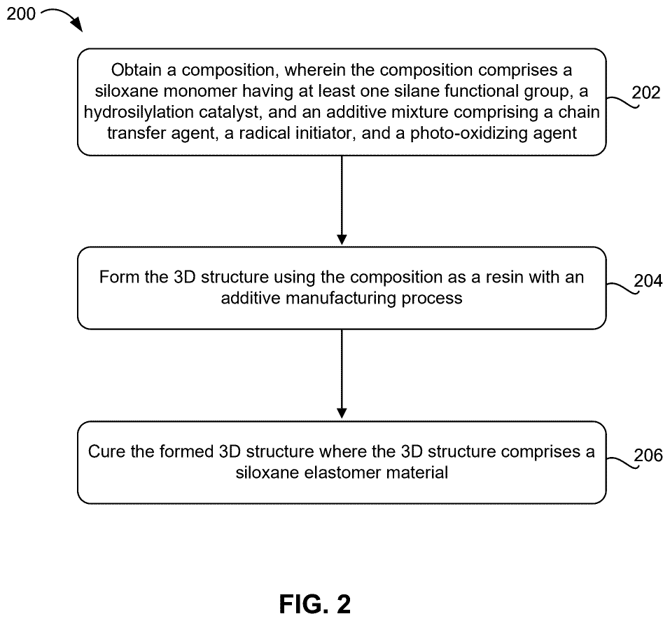

FIG. 3 illustrates the control of the reaction in response to light exposure to the resin. The plot in FIG. 3 demonstrates that the curing reaction only proceeds during exposure of the resin to light, and the curing reaction is stopped in the absence of light. The plot illustrates storage modulus and loss modulus of the resin (y-axis) over time of about 600 seconds (10 minutes), shows that the reaction proceeds with a change in modulus (storage and loss) in response to light exposure “Light on” and in the absence of light exposure “Light off” the modulus is unchanged over the duration of time without light. In this experiment, the resin demonstrates a crossover of storage and loss modulus at almost 400 seconds demonstrating the material changing from liquid to solid during the 3^{rd} period of light exposure. In a conventional resin that does not include the thiol siloxane or photo-oxidizing agent, the duration of time to curing the resin from a liquid to a solid may occur after 10 minutes of light exposure.

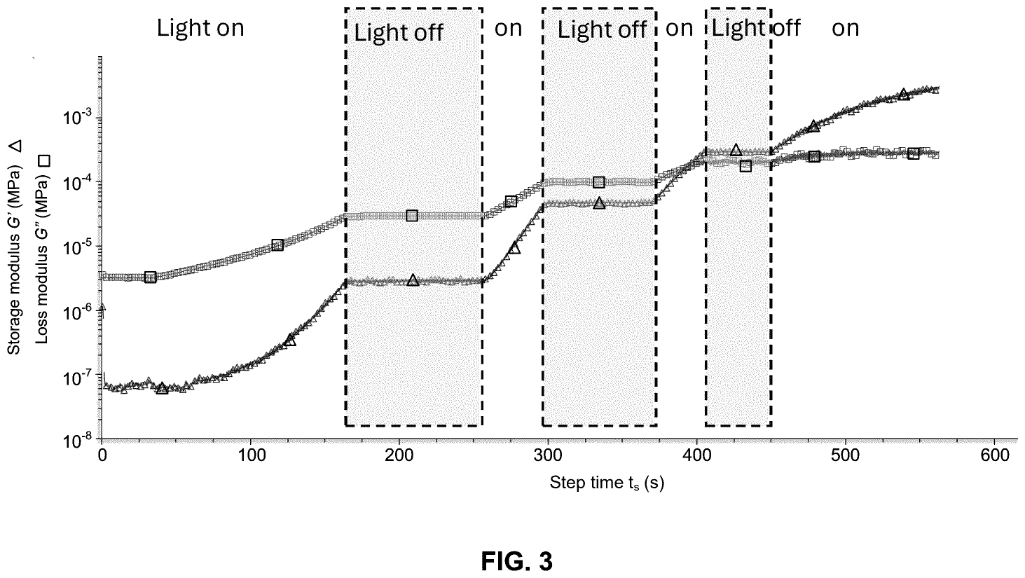

FIG. 4 illustrates a two-dimensional (2D) photo-pattern of “LLL” printed with the silicone resin. Part (a) is a drawing of the “LLL” pattern, and part (b) is an image of the formed 2D silicone structure having the LLL pattern.

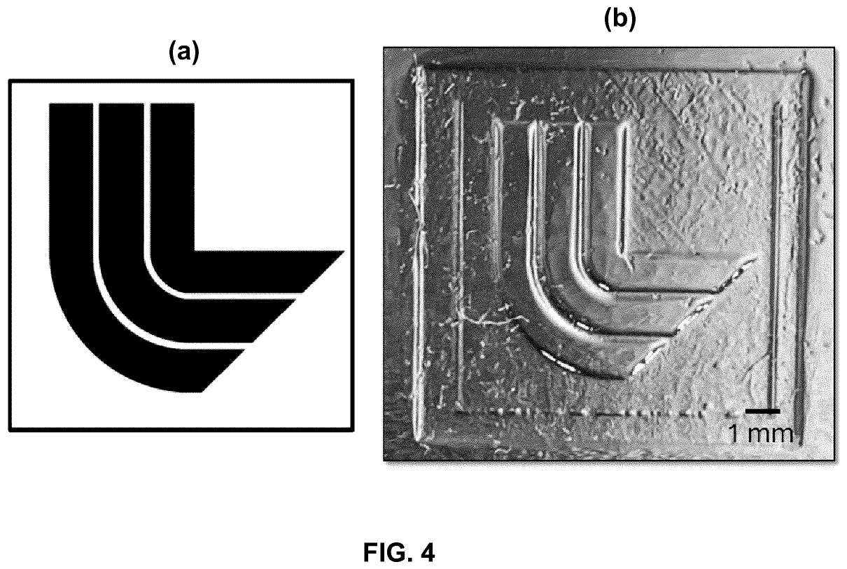

FIG. 5 illustrates a 3D printed attempt of a gyroid structure. Part (a) illustrates a drawing of a gyroid structure, a 3D structure having a complex geometry. Parts (b) and (c) are images of a 3D printed part using the siloxane resin having the photo-oxidizing agent and a thiol siloxane polymer that functions as a chain transfer agent. The structures in the image have a three-dimensional structure with some resolution of the filaments that correspond to the filaments of the gyroid structure in the drawing of part (a).

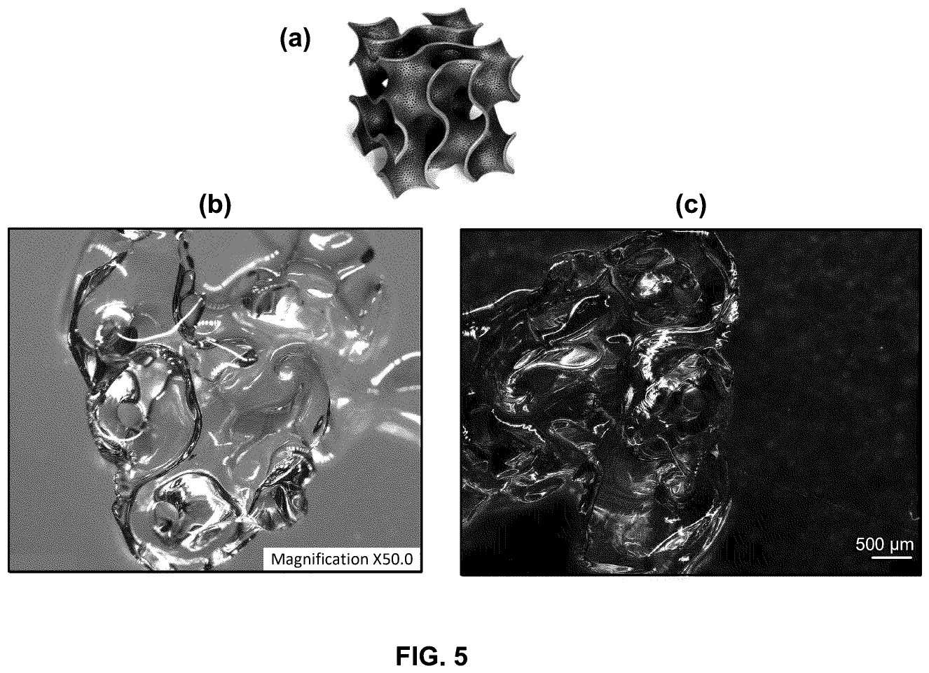

FIG. 6 illustrates the stability of the shelf-life of a siloxane resin, for example, the siloxane resin of part A+part B. The rheology results were compared of a sample of neat silicone resin that does not include the thiol siloxane polymer (e.g., the chain transfer agent) and a resin that includes the thiol siloxane polymer (●). The neat silicone resin undergoes curing in the absence of light at 1000 seconds (about 20 minutes at 60° C.) (illustrated as crossover representing gelation of the resin), whereas a sample that includes 0.2 wt. % thiol siloxane polymer (DMS-SM121) undergoes curing in the absence of light at about 5000 seconds (about 2 hours at 60° C.). Both resins were incubated with oscillatory shear at the elevated temperature of 60° C. Preferably, shelf life of a resin is undisturbed, without light, at room temperature.

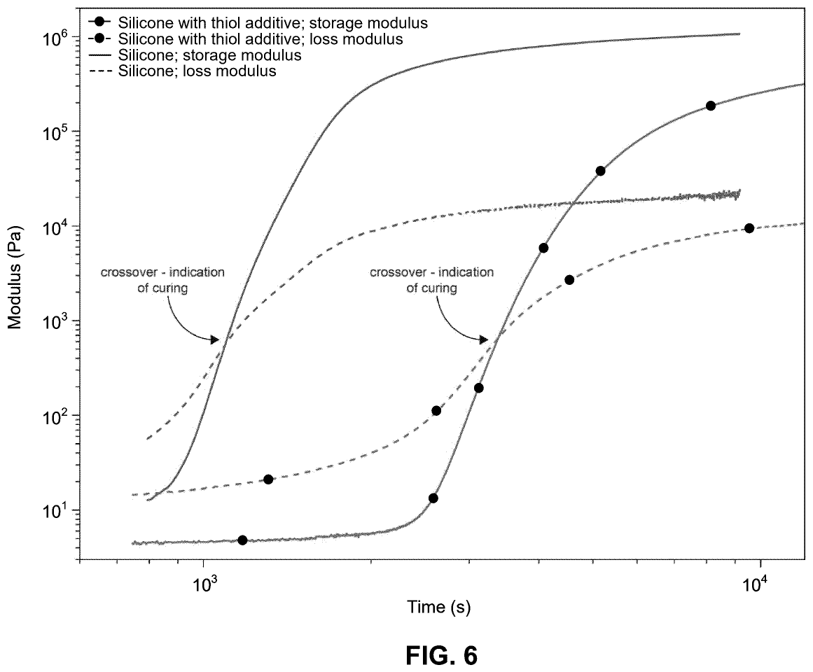

FIG. 7 is a plot of viscosity over shear rate illustrates the stability of the formulation for greater than 2 weeks at room temperature (about 68° F. (20° C.)) as indicated by an increase in viscosity at two weeks that is less than a factor of 5× the original value. Addition of the thiol-based siloxane may increase the shelf stability. The plot illustrates the relationship of viscosity as function of shear rate after different periods of time at room temperature (Day 1, Day 4, and Day 14). There is a slight increase in viscosity after two weeks. In another test, there was a slight decrease in viscosity after two weeks. Thus, there may be a slight measurement error that is reflected in a slight increase or decrease over multiple weeks. These results confirm that the formulation is shelf stable at room temperature, and the additive increases the shelf stability of the siloxane resin.

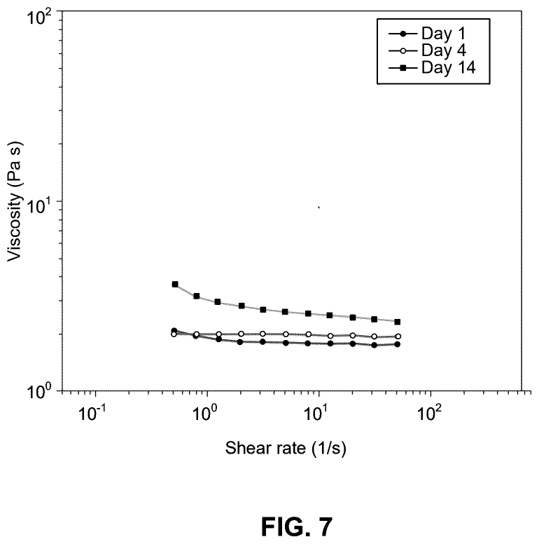

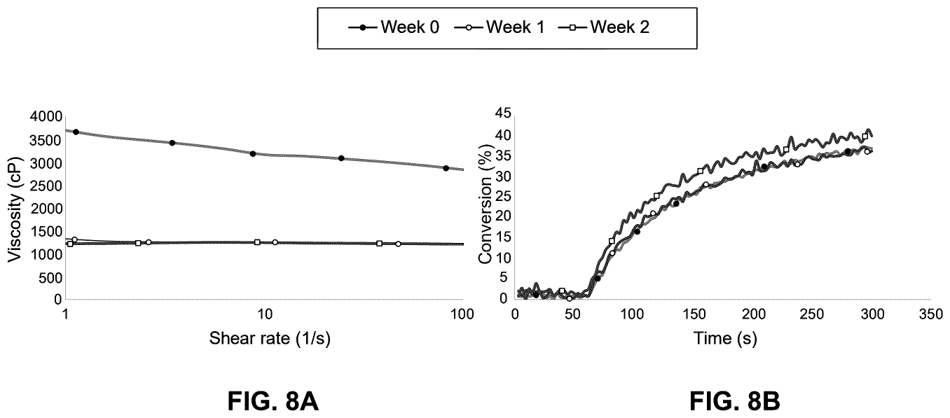

FIGS. 8A and 8B illustrate the similar conversion rate of the formulation at different shelf times (0 week, 1 week, and 2 weeks). The formulation included Sylgard 184 siloxane resin and 0.5 wt. % thiol siloxane polymer, 2 wt. % peroxide, and 0.1 wt. % photoinitiator. Measuring rheometer viscosity as a measure of viscosity over shear rate in FIG. 8A, there is a decrease in viscosity after week 0, but the lower viscosity does not change between weeks 1 and 2. Further data not shown demonstrates that shelf stability has been confirmed for greater than 2 weeks to at least 5 months. Analysis by Fourier Transform Infrared Spectroscopy (FTIR) was used to measure the chemical change of the vinyl functional group of the siloxane monomer as the siloxane is cured and provided a measure the resulting crosslinked polymer in terms of curing conversion rate (%) as illustrated in the plot in FIG. 8B. The % curing conversion rate was similar for the formulation at different shelf lives. The chemistry of the siloxane resin during curing does not change for resins having different shelf times. The formulation having a 2 week shelf life may demonstrate a significant increase in conversion rate compared to the formulation at weeks 0 or 1.

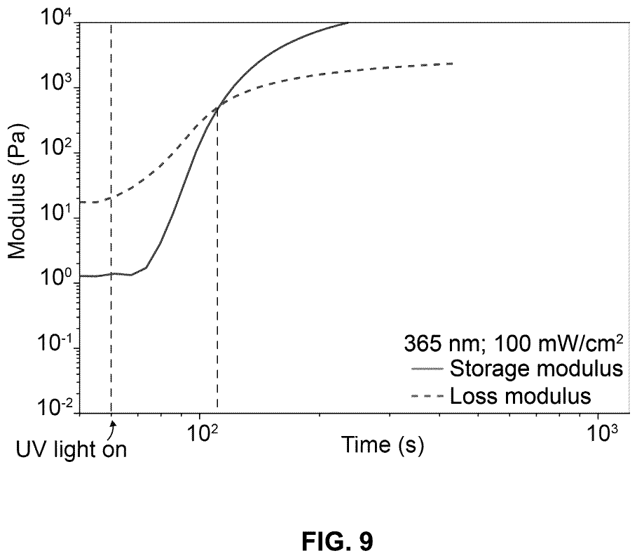

In some approaches, a second additive may be added to the formulation of the composition. For example, a second additive may be a peroxide. FIG. 9 illustrates the conversion rate in terms of modulus conversion that may be increased by the addition of the peroxide Luperox® 231 to the formulation. In the presence of a second additive such as a peroxide, the formulation may cure just under 2 minutes, about 100 seconds.

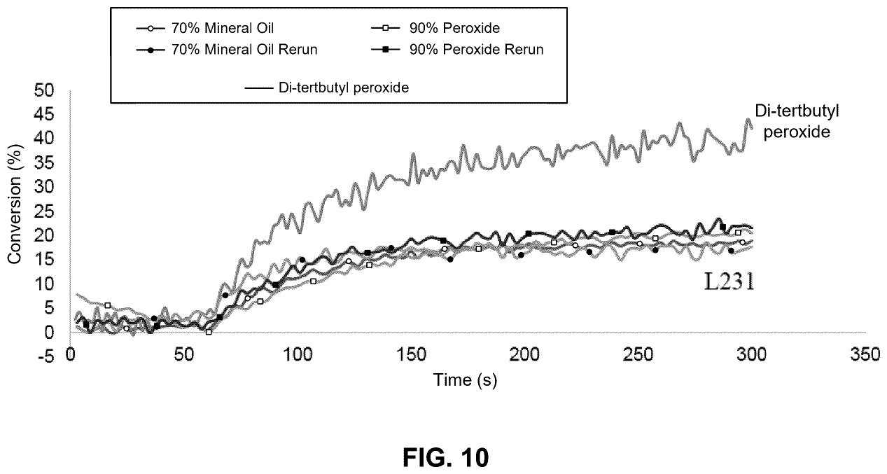

The plot from FTIR analysis depicted in FIG. 10 confirms that including different thermally activated initiators, e.g., peroxides, increase conversion rate. Formulations were tested with different peroxides. Formulations with 70% L231 solubilized in mineral oil (1,1-Di-(tert-butylperoxy)-3,3,5-trimethylcyclohexane, 75% solution in aromatic free mineral spirit), including a rerun (∘ and ●) and 90% pure peroxide (Luperox® 231, 1,1-Bis(tert-butylperoxy)-3,3,5-trimethylcyclohexane (92% purity), including a rerun (□ and ▪) demonstrated similar conversion rates. A formulation with a different commercially available di-tert-butyl peroxide (Luperox® DI, Arkema, Inc., Torrance, CA) demonstrated a remarkably increased curing conversion rate. The plot illustrates measurements of the chemical reaction over time, and the resulting curve may be interpreted as the changes to the chemical reaction (i.e., curing conversion rate (%)) with different peroxides added to the formulation.

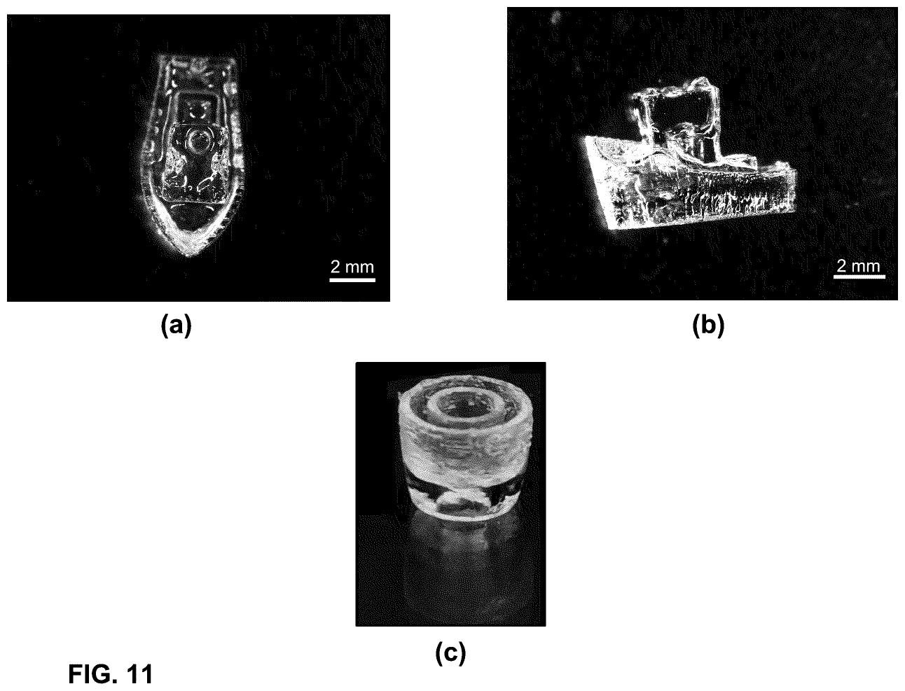

FIG. 11 includes images of 3D printed structures formed using a siloxane formulation that includes a chain transfer agent, photoinitiator, and a thermally activated initiator printed at room temperature. Part (a) depicts a benchmark 3D structure, part (b) is a boat structure having intricate features, and part (c) depicts a printed 3D structure in the shape of an earbud. Each printed 3D structure has high resolution of fine intricate features in the micron ranges (less than 1 mm).

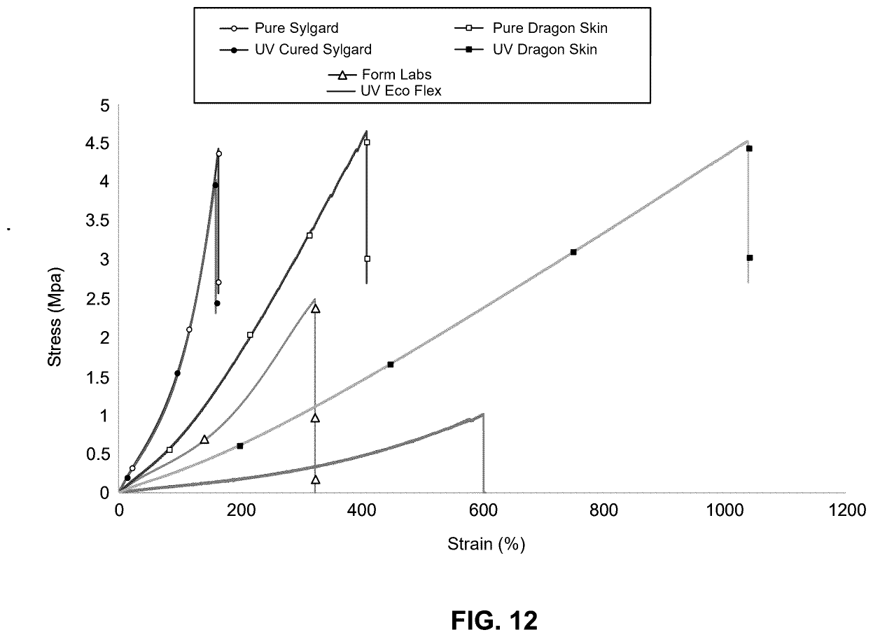

A chain transfer agent may be added to different siloxane formulations that are commercially available to accelerate the curing process that allows spatial and temporal of the photopolymerization process of 3D printing a structure. FIG. 12 illustrates a plot of strain versus stress as an indication of curing with different commercially available siloxane resins with and without the additive mixture described herein. Pure Sylgard resin (∘) does not include thiol siloxane polymer nor any photoinitiator and is cured in an oven. UV-cured Sylgard includes the additive mixture that includes thiol siloxane polymer and photoinitiator and is cured by UV. The traces overlap each other thereby indicating that the mechanical properties of the cured material is unchanged by the photocure formulation. The material cured either thermally or by UV is stiffer having less stretch.

The Form Labs resin (Δ) is a benchmark silicon resin that is printable that uses a different chemistry. The UV Eco Flex is a commercially available siloxane resin that includes the additive mixture having thiol siloxane polymer and photoinitiator and is cured by UV and forms a softer material. The trace of the Eco Flex material formed by UV cure was similar to a trace of a conventional thermal cure of the Eco Flex siloxane resin (not shown).

Pure Dragon Skin (□) is a siloxane resin without the chain transfer agent (thiol siloxane) that was thermally cured, and UV Dragon Skin (▪) includes the additive mixture that includes thiol siloxane polymer and photoinitiator and is cured by UV. These results showed that without the chain transfer agent, the siloxane resin is cured and forms a structure having a range of mechanical properties.

### In Use

Various inventive aspects described herein may be used for additive manufacturing, UV coating, and composites.

The inventive aspects disclosed herein have been presented by way of example to illustrate the myriad features thereof in a plurality of illustrative scenarios, aspects of an inventive aspect, and/or implementations. It should be appreciated that the aspects generally disclosed are to be considered as modular, and may be implemented in any combination, permutation, or synthesis thereof. In addition, any modification, alteration, or equivalent of the presently disclosed features, functions, and aspects that would be appreciated by a person having ordinary skill in the art upon reading the instant descriptions should also be considered within the scope of this disclosure.

While various aspects of an inventive aspect have been described above, it should be understood that they have been presented by way of example only, and not limitation. Thus, the breadth and scope of an aspect of an inventive aspect of the present invention should not be limited by any of the above-described exemplary aspects of an inventive aspect but should be defined only in accordance with the following claims and their equivalents.

What is claimed is:

1. A composition for printing a three-dimensional siloxane structure, the composition comprising:
a siloxane monomer having at least one silane functional group;
a chain transfer agent;
a hydrosilylation catalyst;
a radical initiator; and
a photo-oxidizing agent.

2. The composition as recited in claim 1, wherein the siloxane monomer is selected from the group consisting of: a linear hydride-terminated siloxane monomer, a branched hydride-terminated siloxane monomer, a multifunctional hydride-terminated siloxane monomer, and a combination thereof.

3. The composition as recited in claim 1, wherein the siloxane monomer comprises a silane-terminated siloxane monomer.

4. The composition as recited in claim 1, further comprising a vinyl-functionalized siloxane monomer.

5. The composition as recited in claim 1, wherein an amount of the chain transfer agent is in a range of about 0.01 to about 1 weight % of a total weight of the composition.

6. The composition as recited in claim 1, wherein the chain transfer agent is a thiol siloxane polymer.

7. The composition as recited in claim 6, wherein an amount of the thiol siloxane polymer is in a range of about 0.01 to about 1 weight % of a total weight of the composition.

8. The composition as recited in claim 1, wherein the radical initiator comprises a photoactivated initiator.

9. The composition as recited in claim 8, wherein an amount of the photoactivated initiator is in a range of about 0.01 to about 4.0 weight % of a total weight of the composition.

10. The composition as recited in claim 8, wherein an amount of the photo-oxidizing agent by weight is about equivalent to an amount of the photoactivated initiator.

11. The composition as recited in claim 1, wherein an amount of the photo-oxidizing agent is in a range of about 0.01 weight % to about 4.0 weight % of a total weight of the composition.

12. The composition as recited in claim 1, wherein the hydrosilylation catalyst is a metal-based catalyst having a metal selected from the group consisting of: platinum, rhodium, iridium, and ruthenium.

13. The composition as recited in claim 1, wherein the composition is a resin for forming a structure using a stereolithography additive manufacturing technique.

14. An additive mixture for decreasing a curing time of a siloxane resin under light, the additive mixture comprising:
a chain transfer agent;
a radical initiator; and
a photo-oxidizing agent.

15. The additive mixture as recited in claim 14, wherein the chain transfer agent is a thiol siloxane polymer.

16. The additive mixture as recited in claim 14, wherein the radical initiator comprises a photoactivated initiator and/or a thermally activated initiator.

17. A method of forming a three-dimensional (3D) structure, the method comprising:
obtaining a composition, wherein the composition comprises a siloxane monomer having at least one silane functional group, a hydrosilylation catalyst, and the additive mixture as recited in claim 14;
forming the 3D structure using the composition as a resin with an additive manufacturing process; and
curing the formed 3D structure, wherein the cured 3D structure comprises a siloxane elastomer material.

18. The method as recited in claim 17, wherein the radical initiator comprises a photoactivated initiator and/or a thermally activated initiator,
wherein the curing includes exposure to light.

19. A method for extending a shelf life of a siloxane resin includes adding an effective amount of a thiol siloxane polymer to result in extending the shelf life of the siloxane resin by at least a year.

20. The method as recited in claim 19, wherein the effective amount of the thiol siloxane polymer is in a range of at least 0.01 weight % to about 10 weight % of the total weight of the siloxane resin.
